(19) United States
(12) Patent Application Publication
(10) Pub. No.: US 2007/0056798 A1
(43) Pub. Date: Mar. 15, 2007

(54) Fire shelter with an escape ladder

(76) Inventor: Feng-Jui Lee, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,119

(22) Filed: Sep. 14, 2005

(51) Int. Cl. A62B 1/06

(52) U.S. Cl. 182/76

(57) ABSTRACT

The present invention discloses a fire shelter with an escape ladder, wherein multiple fireproof boards are installed to the walls of a chamber, and the seams of the door are sealed; thereby, a shelter, which can retard the flame and fume of a fire, is formed. An escape apparatus is installed inside the fire shelter, wherein at least two I-shaped sliding channels are installed before an escape window and higher than the lower border of the escape window; an expansible sliding frame is installed between the I-shaped sliding channels and can slide and expand along the I-shaped sliding channels; a rope ladder is installed to a transverse beam above the expansible sliding frame and is able to hangs down outside the escape window; an auxiliary apparatus is used to release the rope ladder gradually; thus, people can escape from the fire shelter one by one via the rope ladder.

### BACKGROUND OF THE INVENTION

1. Field of the Invention

The present invention relates to a fire shelter, particularly to a fire shelter with an escape ladder.

2. Description of the Related Art

With extensive urbanization, high population density and expensive land price encourages high-rise buildings to grow taller and taller, and sometimes even to such a height that the ladder truck cannot access the fire floor, which makes fire extinguishment very difficult. In spite of sophisticated fire-protection equipments, many lives were still killed in fires.

A fire usually occurs unexpectedly and spreads very quickly. If a person cannot escape from a fire within the golden ten minutes, his survival chance will be very little. When a fire occurs, the staircase may be full of flame and fume; thus, people usually run to the height to look for the rescue of a helicopter. It is dangerous for people to gather and wait for the helicopter rescue on the top of the burning building; further, the helicopter rescue itself also has a risk. Therefore, if people have another method to escape from a burning building without passing through a smoldering staircase, may fewer lives be killed in a fire.

Accordingly, the present invention proposes a fire shelter with an escape ladder to solve the abovementioned problems.

### SUMMARY OF THE INVENTION

The primary objective of the present invention is to provide a fire shelter with an escape ladder, wherein multiple fireproof boards are used to construct a chamber, which can retard the flame and fume of a fire and can temporarily provide shelter for people so that the people can have a buffer time to escape via a rope ladder.

Another objective of the present invention is to provide a fire shelter with an escape ladder, wherein an auxiliary apparatus can enable the rope ladder to be released in multiple stages so that the damage on the rope ladder resulting from the drag force of the fast falling rope ladder can be avoided.

Further objective of the present invention is to provide a fire shelter with an escape ladder, which comprises I-shaped sliding channels and an expansible sliding frame, wherein the expansible sliding frame can extend out the escape window, and the user can stand on the expansible sliding frame and slide out the escape window and climb down along the rope ladder and then escape from the fire.

To achieve the aforementioned objectives, the present invention proposes a fire shelter with an escape ladder, which comprises: multiple hollow steel columns, installed along the walls of a chamber, wherein each steel column has a jack on its top to support the floor overhead and has a pad below its bottom to concentrate the force; multiple fireproof boards, installed on the walls of the chamber to block flame and fume; at least two I-shaped sliding channels, installed before an escape window and higher than the lower border of the escape window; multiple load-bearing rollers, installed below the I-shaped sliding channels; an expansible sliding frame, installed between the I-shaped sliding channels and above the load-bearing rollers, wherein the expansible sliding frame can slide along the I-shaped sliding channels and extend out the escape window; and a rope ladder, installed on a transverse beam above the expansible sliding frame, and able to hang down outside the escape window, and able to be released in multiple stages via an auxiliary apparatus, and used to escape from a fire.

Via the embodiments of the present invention described below in detail, the objectives, technical contents, characteristics, and accomplishments of the present invention will be more easily understood.

### BRIEF DESCRIPTION OF THE DRAWINGS

FIG. 1 is a section view of the present invention.

FIG. 2 is a top view of the present invention.

FIG. 3 is a front view of the present invention.

FIG. 4 and FIG. 5 are schematic diagrams showing that the user utilizes the rope ladder to escape from a fire.

### DETAILED DESCRIPTION OF THE INVENTION

The present invention provides a fire shelter with an escape ladder, which is to be used when there is a fire in a high-rise building, wherein a chamber is constructed to be a shelter which the flame and fume of a fire is hard to enter into, and an escape apparatus is also installed inside the shelter so that people will have enough time to escape from the burning building via the escape apparatus before the fire enters into the shelter.

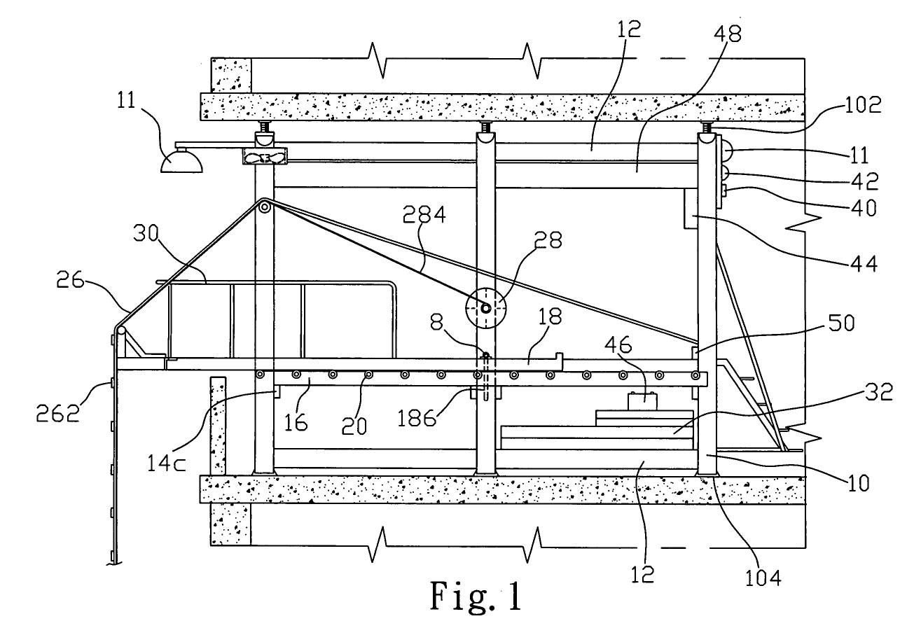

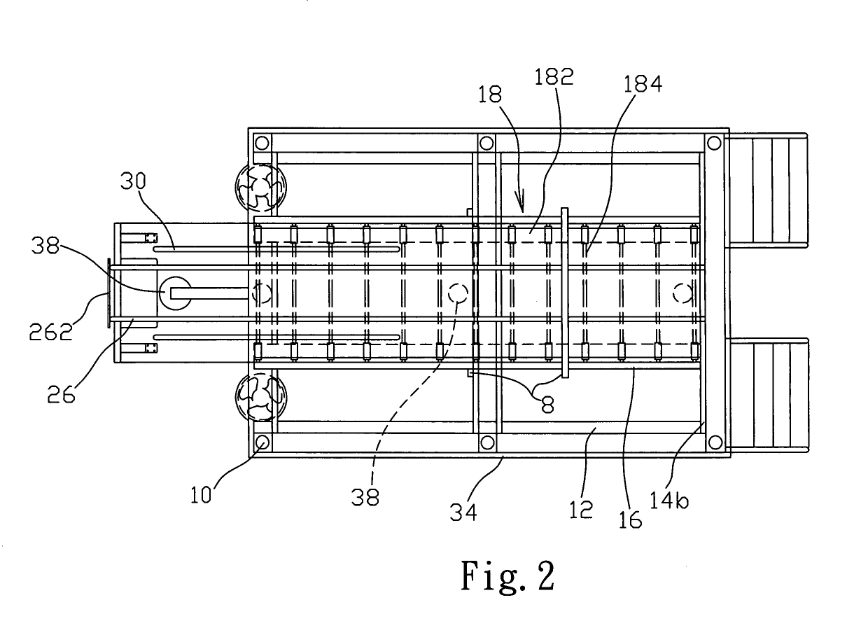

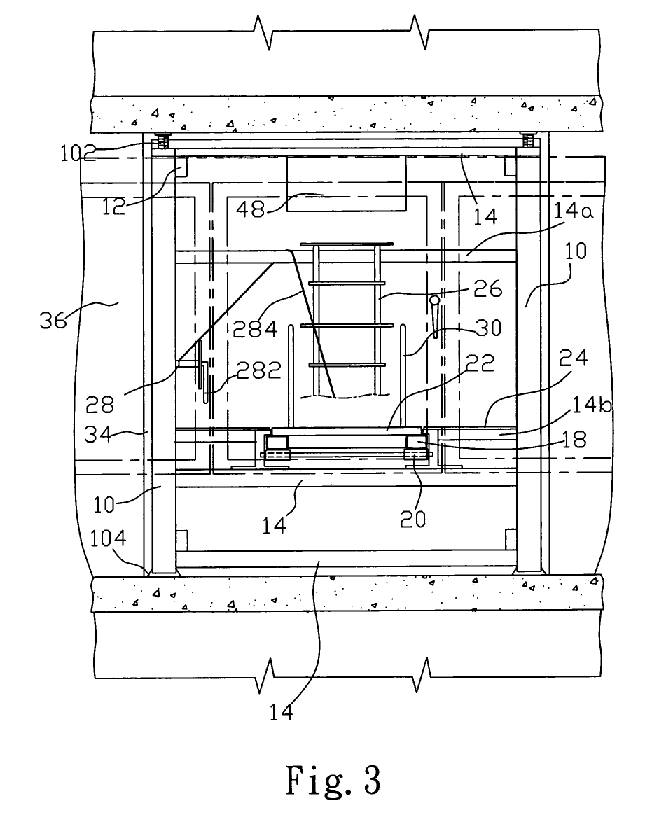

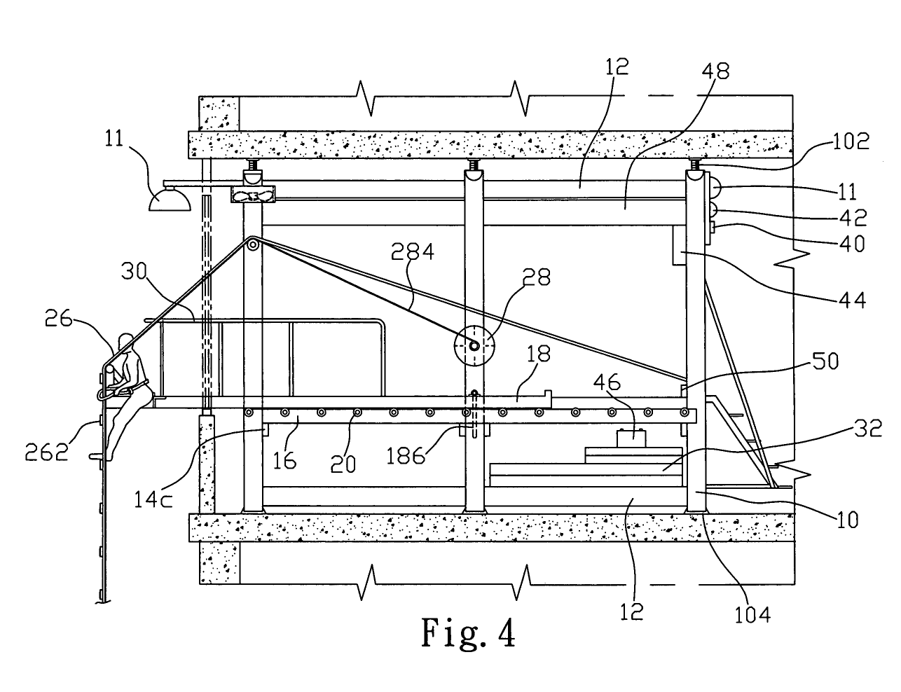

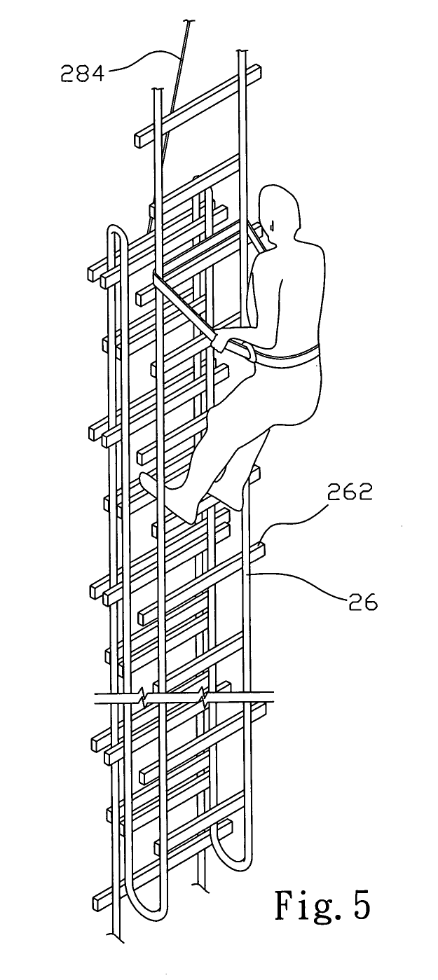

Refer to from FIG. 1 to FIG. 3. In the fire shelter with an escape ladder according to the present invention, multiple hollow steel columns 10 are installed along the walls of the shelter, and each steel column 10 has a jack 102 on its top to support the floor overhead and has a pad 104 below its bottom to concentrate the force; multiple lateral beams 12 and multiple transverse beams 14 are separately installed between every two steel columns 10 to enhance the structure. Multiple fireproof boards 34 of a thickness having capability of enduring a temperature ranging from 3000 to 4000° C. are separately installed on the walls of four sides of the shelter, and the seams of the door can be tightly sealed lest the fume run in and so that the user can have enough time to escape. At least two I-shaped sliding channels 16 are installed before an escape window 36 and higher than the lower border of the escape window 36. Multiple load-bearing rollers 20 are installed below the I-shaped sliding channels 16; an anti-slip steel plate 22 is installed above the I-shaped sliding channels 16 so that the user can walk thereon safely without the danger of slip. An expansible sliding frame 18 is installed between the I-shaped sliding channels 16 and above the load-bearing rollers 20 and below the anti-slip steel plate 22. The expansible sliding frame 18 comprises two parallel long rods 182 and multiple transverse bars 184 that are vertical to the long rods 182. The expansible sliding frame 18 can slide and expand along the I-shaped sliding channels 16. A rope ladder 26 made of a fireproof material is installed inside the fire shelter. One end of the rope ladder 26 is fixed to beside the door of the shelter, and the other end of the rope ladder 26 passes over the transverse beam 14a and then hangs down before the expansible sliding frame 18. When the expansible sliding frame 18 extends out an escape window 36, the rope ladder 26 will hang down outside the escape window 36. After fastening the safety belt, the user can descend along the rope ladder 26 to escape from the burning building.

Anti-slip step boards 24 are installed beside the anti-slip steel plate 22 and function as the anti-slip steel plate 22 does. As the anti-slip steel plate 22 spans the expansible sliding frame 18, it is necessary for the anti-slip steel plate 22 to use a tough material, such as steel, lest it be bent or fractured by the user's weight. In contrast to the anti-slip steel plate 22, the anti-slip step boards 24 are supported by the transverse beams 14b. Two hand rails 30 for the user's holding are installed between two long rods 182 of the expansible sliding frame 18, and the front portion of the hand rails stretches over the I-shaped sliding channels 16 and extends out the escape window 36. At least one fixing element 186 is installed in the middle portion of the expansible sliding frame 18 in order to fix the non-expansible portion of the expansible sliding frame 18, which stays within the I-shaped sliding channels 16, lest the gravity drive the expansible sliding frame 18 to slide forward when the user stands at its front end. As the I-shaped sliding channels 16 are heavy and long, two transverse beams 14c are separately installed under the front end and the rear end thereof to support and fix it, and two block elements 50 are separately installed on the front end and the rear end thereof also to support and fix the I-shaped sliding channels 16. Balance weights 32, which can provide a balance force of about 500 kg, are installed in near the entrance of the shelter and below the I-shaped sliding channels 16. A storage battery 46 is disposed on the balance weight 32, and when the power supply is cut off by fire, the storage battery 46 can provide enough power for the shelter.

Multiple ladder bars 262, which may be made of an aluminum alloy, are installed to the rope ladder 26 periodically at a given interval. The ladder bars 262 have a design that long bars and short bars are alternately arranged along the rope ladder 26, wherein each long ladder bar 262 has two protruding ends. After the user has fastened the safety belt to his waist, he can put the loop of the safety belt around the long ladder bar 262; even though the loop slips away from one long ladder bar 262, two protruding ends of the next long ladder bar 262 can still hook the loop lest the user fall down. In the present invention, an auxiliary apparatus 28 is used to release the rope ladder 26, wherein a rocker 282 enables the rope ladder 26 to descend slowly. Further, multiple rope hooks 284 are used to fold the rope ladder 26 into multiple sections, and when the user reaches the bottom of one section of the rope ladder 26, he can cut off the rope hook 284 of the next section, and thus, the next section of rope ladder 26 is released. Thereby, the damage on the rope ladder 26 or on the expansible sliding frame 18, which results from the rapid falling of the entire rope ladder 26, can be avoided.

The present invention may further comprises: multiple emergency lights 38, which are charged routinely and are initiated once power is off; an alarm device 40, automatically generating an alarm sound when a fire happens; an alarm light 42, flickering when a fire happens; a storage box 48, which safety belts, antismoke masks, first-aid medicine, and drinking water can be stored inside; and an independent distribution box 44, which can maintain the operation of the shelter when the power is cut off by fire.

Those embodiments disclosed above are only to clarify the present invention and not intended to limit the scope of the present invention. Any equivalent modification and variation according to the spirit of the present invention is to be included within the scope of the present invention.

What is claimed is:

1. A fire shelter with an escape ladder, comprising:
multiple steel columns, separately installed along the walls of a chamber, wherein each said steel column has a jack on its top to support the floor overhead and has a pad below its bottom to concentrate the force;
multiple fireproof boards, separately installed on the walls of said chamber;
at least two I-shaped sliding channels, horizontally installed before an escape window, and higher than the lower border of said escape window, with multiple load-bearing rollers installed below said I-shaped sliding channels;
an expansible sliding frame, installed between said I-shaped sliding channels and above said load-bearing rollers, wherein said expansible sliding frame can slide and expand along said I-shaped sliding channels; and
a rope ladder, installed to a transverse beam above said expansible sliding frame, and able to hang down outside said escape window.

2. The fire shelter with an escape ladder according to claim 1, wherein said steel columns are hollow.

3. The fire shelter with an escape ladder according to claim 1, wherein multiple lateral beams and multiple transverse beams are separately installed between said steel columns to enhance and fix said steel columns.

4. The fire shelter with an escape ladder according to claim 3, wherein said I-shaped sliding channels are installed on said transverse beams.

5. The fire shelter with an escape ladder according to claim 1, wherein multiple transverse rods are installed between said I-shaped sliding channels, and an anti-slip steel plate is installed above said transverse rods.

6. The fire shelter with an escape ladder according to claim 1, wherein said expansible sliding frame is formed of two parallel long rods and multiple transverse bars, which are disposed between and vertical to said two long rods.

7. The fire shelter with an escape ladder according to claim 1, wherein two hand rails are installed between said two long rods of said expansible sliding frame for the user's holding, and said hand rails and said expansible sliding frame can stretch over I-shaped sliding channels and extend out said escape window.

8. The fire shelter with an escape ladder according to claim 1, wherein said rope ladder is made of a fireproof material.

9. The fire shelter with an escape ladder according to claim 1, wherein an auxiliary apparatus is installed to one said steel column positioned at the middle of said shelter to release said rope ladder, and said auxiliary apparatus has at least two rope hooks that can hook said rope ladder and control the length by which said rope ladder is released each time.

10. The fire shelter with an escape ladder according to claim 9, wherein said auxiliary apparatus uses a rocker to regulate the falling speed of said rope ladder; when the release of said rope ladder is stopped by one said rope hook, said rope ladder can be released further via cutting off said rope hook.

11. The fire shelter with an escape ladder according to claim 1, wherein at least one fixing element is installed in the middle portion of said expansible sliding frame in order to fix the non-expansible portion of said expansible sliding frame.

12. The fire shelter with an escape ladder according to claim 1, wherein multiple balance weights are installed in near the walls on both sides of the entrance of said shelter, and said balance weights can provide a balance force of about 500 kg.

13. The fire shelter with an escape ladder according to claim 1, wherein multiple emergency lights are installed inside said shelter.

14. The fire shelter with an escape ladder according to claim 1, wherein an alarm device and an alarm light are installed inside said shelter to generate alarm signals.

15. The fire shelter with an escape ladder according to claim 1, wherein a storage battery and a distribution box are installed inside said shelter.
